(19) United States
(12) Patent Application Publication
(10) Pub. No.: US 2012/0268437 A1
(43) Pub. Date: Oct. 25, 2012

(54) IMAGE DISPLAY DEVICE AND COLOR CORRECTION METHOD USED BY THE SAME

(76) Inventor: Duk-Jin LEE, Yongin-City (KR)

(21) Appl. No.: 13/303,496

(22) Filed: Nov. 23, 2011

(30) Foreign Application Priority Data
Apr. 22, 2011 (KR) 10-2011-0037857

(51) Int. Cl. G09G 5/00

(52) U.S. Cl. 345/207

(57) ABSTRACT

Embodiments may be directed to an image display device and a color correction method. An image display device may include a display unit displaying an image according to an image signal; a sensor unit measuring a spectrum of external light incident on the display unit; and a correction signal providing unit estimating an adapted primary color spectrum perceived by a viewer using spectral reflectivity of the display unit, a maximum level primary color spectrum of the display unit, and the spectrum of external light, and providing a correction signal for correcting the image signal based on the adapted primary color spectrum.

### CROSS-REFERENCE TO RELATED APPLICATION

This application claims priority from Korean Patent Application No. 10-2011-0037857 filed on Apr. 22, 2011 in the Korean Intellectual Property Office, the disclosure of which is incorporated herein by reference in its entirety.

### BACKGROUND

1. Field

Embodiments relate to an image display device and a color correction method used by the same.

2. Description of the Related Art

An image display device displays an image according to an image signal. A viewer sees the image displayed on the image display device. A viewer's visual environment is usually exposed to external light. Thus, the viewer sees an image in external light, which may limit visibility of the image.

### SUMMARY

According to an embodiment, there may be an image display device including a display unit displaying an image according to an image signal; a sensor unit measuring a spectrum of external light incident on the display unit; and a correction signal providing unit estimating an adapted primary color spectrum perceived by a viewer using spectral reflectivity of the display unit, a maximum level primary color spectrum of the display unit, and the spectrum of the external light, and providing a correction signal for correcting the image signal based on the adapted primary color spectrum.

According to another embodiment, there may be a color correction method used by an image display device, the method including measuring, in real time, a spectrum of external light incident on a display unit; estimating an adapted primary color spectrum perceived by a viewer using spectral reflectivity of the display unit, a maximum level primary color spectrum of the display unit, and the spectrum of the external light; and providing a correction signal for correcting an image signal based on the adapted primary color spectrum, wherein the display unit displays an image according to the image signal.

### BRIEF DESCRIPTION OF THE DRAWINGS

The above and other features of present embodiments will become more apparent by describing in detail exemplary embodiments thereof with reference to the attached drawings, in which:

FIG. 1 is a block diagram of an image display device according to an exemplary embodiment;

FIG. 2 is a block diagram of a correction signal providing unit shown in FIG. 1;

FIG. 3 is a block diagram of a luminance correction data calculation unit shown in FIG. 1;

FIG. 4 is a schematic diagram illustrating a visual environment in which the image display device according to present embodiments is used;

FIG. 5 is a schematic diagram illustrating the process of estimating an adapted primary color spectrum;

FIG. 6 shows data on the chromaticity coordinates and required luminance ratio of primary colors calculated according to illuminance of external light;

FIG. 7 shows data on color correction data and a gamma set calculated according to illuminance of external light; and

FIG. 8 is a flowchart illustrating a color correction method used by the image display device of FIG. 1 according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein.

The terminology used herein is for the purpose of describing particular embodiments only and is not intended to be limiting of present embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

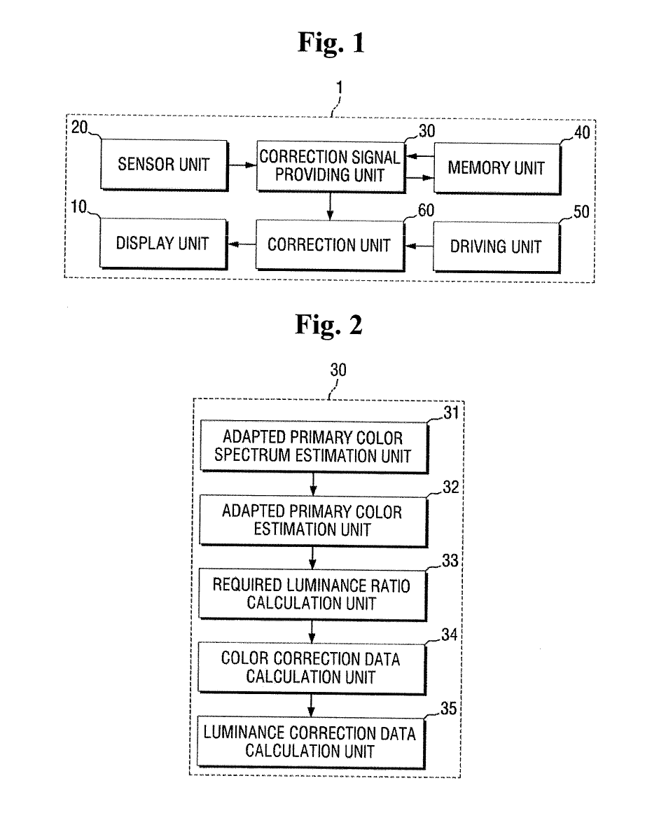

FIG. 1 is a block diagram of an image display device 1 according to an exemplary embodiment. Referring to FIG. 1, the image display device 1 according to the current exemplary embodiment includes a display unit 10, a sensor unit 20, and a correction signal providing unit 30.

The display unit 10 displays an image according to an image signal. The display unit 10 may be, but is not limited to, any one of a liquid crystal display (LCD), a plasma display panel (PDP), an electroluminescent display (ELD), a light-emitting diode (LED), and a vacuum fluorescent display (VFD).

The sensor unit 20 measures the spectrum of external light incident on the display unit 10. The external light, as used herein, may be defined as light emitted from light sources other than a display source. The display source is a light source installed within the image display device 1. The display source may be a backlight in a light-receiving device (such as an LCD) and may be a light-emitting unit in a self-luminous device. The external light may encompass all light (including sunlight and lighting) emitted from light sources located outside the image display device 1.

Data on the spectrum of the external light which is measured by the sensor unit 20 is provided to the correction signal providing unit 30.

The sensor unit 20 may include, e.g., a photodiode. The sensor unit 20 may be provided outside or inside the display unit 10.

Since the sensor unit 20 measures the spectrum of the external light, accurate data needed to identify characteristics of the external light can be obtained. For example, the relationship characteristics between the wavelength of the external light and the spectrum intensity of the external light can be identified based on measured data. The more accurate the data measured by the sensor unit 20, the more accurately the spectrum of reflected light and adapted primary color spectrum can be estimated.

The correction signal providing unit 30 estimates an adapted primary color spectrum using the spectral reflectivity of the display unit 10, the maximum level primary color spectrum of the display unit 10, and the spectrum of the external light, and provides a correction signal for correcting an image signal based on the adapted primary color spectrum.

A viewer is affected by a visual environment. For example, a viewer may be affected by external light. Since the external light is reflected by a display, the viewer may see a color-distorted image on the display due to the reflected light. Therefore, color distortion by the reflected light needs to be corrected.

To correct color distortion, the correction signal providing unit 30 identifies a degree of color distortion by estimating the color perceived by a viewer and provides a correction signal for correcting the color based on the identified degree of color distortion. First, the correction signal providing unit 30 calculates a spectrum entering a viewer's eyes using the spectral reflectivity, the maximum level primary color spectrum, and the spectrum of external light. The spectrum entering the viewer's eyes denotes an adapted primary color spectrum perceived by the viewer. Next, the correction signal providing unit 30 identifies a degree of color distortion based on the adapted primary color spectrum and provides a correction signal for correcting an image signal based on the degree of distortion of the adapted primary color spectrum.

The correction signal is generated by reflecting color correction data related to the adjustment of hues of primary colors of the display unit 10 and luminance correction data related to the adjustment of luminances of the primary colors of the display unit 10. The color and luminance of the display unit 10 are corrected using the correction signal. Accordingly, a change in color due to external light is reduced, and a decrease in luminance is reduced, thereby increasing color visibility.

In some other embodiments, the image display device 1 may further include a memory unit 40, a driving unit 50, and a correction unit 60.

The memory unit 40 stores data on properties of the image display device 1. The data on the properties of the image display device 1 may include the maximum level primary color spectrum, spectral reflectivity, and target white color of the display unit 10. However, present embodiments are not limited thereto, and data on various properties of the image display device 1 may be stored in the memory unit 40 before the image display device 1 is shipped.

In addition, the memory unit 40 may be used as a space in which data being calculated is temporarily stored while the color correction data and the luminance correction data are calculated by the correction signal providing unit 30.

In some embodiments, a correction signal provided by the correction signal providing unit 30 may be sent to the correction unit 60 via the memory unit 40. For example, the correction signal may be temporarily stored in the memory unit 40. Then, the memory unit 40 may provide the stored correction signal to the correction unit 60.

Data stored in the memory unit 40 will now be described in detail below.

Spectral reflectivity is data on the degree by which a surface of the display unit 10 reflects the spectrum of external light. For example, the spectral reflectivity may be represented by the relationship between wavelength and the reflectivity of the display unit 10. The spectral reflectivity may be measured before the image display device 1 is shipped and may be stored in the memory unit 40. The spectral reflectivity of the display unit 10 may be applied irrespective of the type of external light and may be used to estimate the spectrum of reflected light produced as the external light is reflected by the display unit 10.

Color reproducing devices typically use three primary colors of red (R), green (G), and blue (B). The range of colors that can be reproduced by a color reproducing device is determined by primary colors that the color reproducing device uses. The primary colors of the display unit 10 and their spectra may be measured before the image display device 1 is shipped and may be stored in the memory unit 40.

The maximum level primary color spectrum is data used to estimate the adapted primary color spectrum. The maximum level primary color spectrum is measured before the image display device 1 is shipped and may be stored in the memory unit 40.

The target white color is a predetermined white color of the display unit 10. The target white color of the display unit 10 may be determined before the image display device 1 is shipped and may be stored in the memory unit 40.

The driving unit 50 provides an image signal, which contains information about an image to be displayed, to the correction unit 60.

The correction unit 60 receives the image signal from the driving unit 50 and the correction signal from the correction signal providing unit 30. Then, the correction unit 60 corrects the image signal using the correction signal and provides the corrected image signal to the display unit 10.

The image display device 1 operates as follows. The sensor unit 20 provides data on the spectrum of external light to the correction signal providing unit 30, and the correction signal providing unit 30 provides a correction signal to the correction unit 60. The driving unit 50 also provides an image signal to the correction unit 60. Then, the correction unit 60 corrects the image signal based on the correction signal and provides the corrected image signal to the display unit 10. The display unit 10 corrects the hues and luminances of its primary colors based on the corrected image signal.

FIG. 2 is a block diagram of the correction signal providing unit 30 shown in FIG. 1. Referring to FIG. 2, the correction signal providing unit 30 includes an adapted primary color spectrum estimation unit 31, an adapted primary color estimation unit 32, a required luminance ratio calculation unit 33, a color correction data calculation unit 34, and a luminance correction data calculation unit 35.

The adapted primary color spectrum estimation unit 31 may estimate an adapted primary color spectrum perceived by a viewer using the spectral reflectivity of the display unit 10, the maximum level primary color spectrum of the display unit 10, and the spectrum of external light.

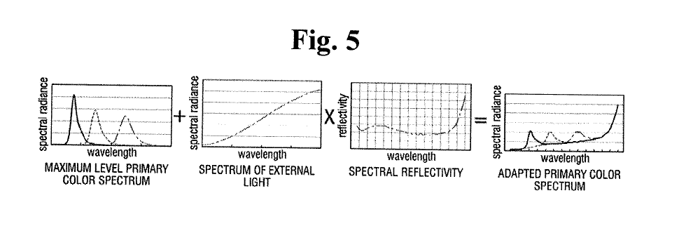

A detailed description of the adapted primary color spectrum estimation unit 31 will be given with reference to FIGS. 4 and 5. FIG. 4 is a schematic diagram illustrating a visual environment in which the image display device 1 according to present embodiments is used. FIG. 5 is a schematic diagram illustrating the process of estimating an adapted primary color spectrum.

Referring to FIG. 4, a visual environment of a viewer is exposed to external light. The external light is incident on the display unit 10 and reflected by the display unit 10 to produce reflected light. Since both light emitted from the display source and the reflected light enter the viewer's eyes, the color perceived by the viewer has relatively lower luminance than that of the color intended by the display source and has a different hue from that of the color intended by the display source.

If the color perceived by a viewer can be estimated, the degree of color distortion can be identified. To estimate the color perceived by the viewer, an adapted primary color spectrum perceived by the viewer may be calculated. Light entering the viewer's eyes includes light emitted from the display source and the reflected light. Thus, a mixed spectrum of both light sources can be estimated with reference to FIG. 5.

To estimate the adapted primary color spectrum, the spectrum of the reflected light is calculated. The spectrum of the reflected light can be calculated using the spectrum of the external light, which is measured in real time by the sensor unit 20, and the surface reflectivity of the display unit 10. For example, the spectral radiance of the external light at each wavelength may be multiplied by the spectral reflectivity of the display unit 10 at each wavelength to calculate the spectrum of light reflected by the display unit 10 among the spectrum of the external light. Consequently, the spectral radiance of the reflected light at each wavelength can be calculated, and the spectrum of the reflected light can be estimated based on the spectral radiance of the reflected light at each wavelength.

Then, the spectrum of the display source may be added to the spectrum of the reflected light. The spectrum of the display source may be, for example, the maximum level primary color spectrum of the display unit 10. Therefore, the adapted primary color spectrum may be calculated by adding the spectrum of the reflected light and the maximum level primary color spectrum of the display unit 10.

The sensor unit 20 measures the spectrum of external light, which is used to calculate an adapted primary color spectrum, in real time and provides data on the measured spectrum of the external light to the adapted primary color spectrum estimation unit 31. In addition, the memory unit 40 provides data on the spectral reflectivity of the display unit 10 and the maximum level primary color spectrum of the display unit 10 to the adapted primary color spectrum estimation unit 31. Therefore, the adapted primary color spectrum estimation unit 31 can estimate the adapted primary color spectrum in real time. In other words, even when a viewer's visual environment changes (e.g., changes in external light), the adapted primary color spectrum according to the changed visual environment can be estimated in real time.

The adapted primary color estimation unit 32 estimates adapted primary colors using the adapted primary color spectrum. The adapted primary colors denote colors that are perceived by a viewer as the primary colors of the display unit 10 in external light.

To estimate the adapted primary colors, tristimulus values of the adapted primary color spectrum are calculated, and chromaticity coordinates of the adapted primary colors are calculated.

The tristimulus values used herein denote CIE tristimulus values. The CIE tristimulus values are derived from the R, G and B primary colors and represented by X, Y and Z. To calculate the tristimulus values for a surface color, spectral distribution S(λ) of a light source is obtained from the adapted primary color spectrum. Then, the spectral distribution S(λ) of the light source is multiplied by each of R, G, and B color matching functions x(λ), y(λ), and z(λ), and values of the multiplication results are added for all visible wavelengths to produce the tristimulus values X, Y, and Z. The R, G, and B color matching functions x(λ), y(λ), and z(λ) are values calculated under standard conditions including a CIE standard observer.

The tristimulus values X, Y, and Z may be given by Equation (1) below. The tristimulus values X, Y, and Z of the adapted primary color spectrum may be given by Equation (1).

X=K ∫_{λ2}^{λ1}S(λ)·x(λ)·dλ (λ1=780 nm, λ2=380 nm)

Y=K ∫_{λ2}^{λ1}S(λ)·y(λ)·dλ λ1=780 nm, λ2=380 nm)

Z=K ∫_{λ2}^{λ1}S(λ)·z(λ)·dλ (λ1=780 nm, λ2=380 nm) (1).

The chromaticity coordinates of the adapted primary colors may be calculated using the tristimulus values of the adapted primary color spectrum. Chromaticity refers to color information unrelated to brightness. Chromaticity coordinates (x, y) may be given by Equation (2).

x=X/(X+Y+Z)

y=Y/(X+Y+Z) (2).

Chromaticity coordinates of each of the R, G, and B primary colors may be calculated using Equation (2). The chromaticity coordinates of R, G, and B may be represented by (Rx, Ry), (Gx, Gy), and (Bx, By), respectively.

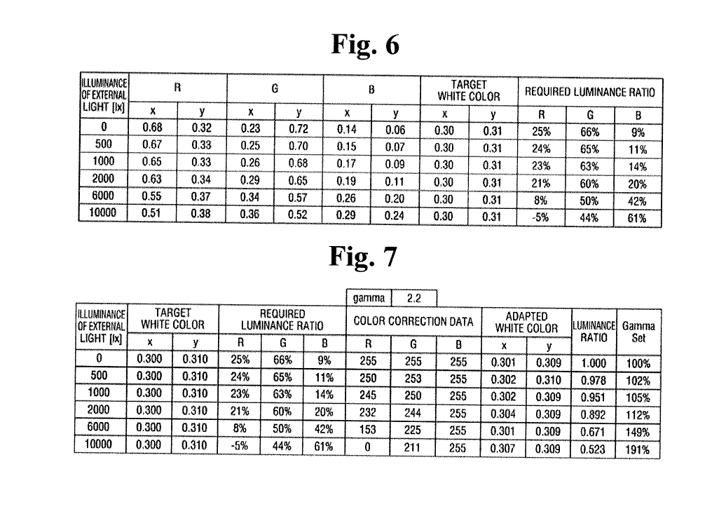

The adapted primary color estimation unit 32 will now be described in detail with reference to FIG. 6. FIG. 6 shows data on the chromaticity coordinates and required luminance ratio of primary colors calculated according to illuminance of external light.

Referring to FIG. 6, adapted primary colors change according to the illuminance of external light. Since an adapted primary color spectrum varies according to the illuminance of the external light, the adapted primary colors estimated based on the adapted primary color spectrum also vary according to the illuminance of the external light. Ultimately, although a viewer sees light emitted from the same display source, the color perceived by the viewer may vary according to external light.

The required luminance ratio calculation unit 33 calculates a required luminance ratio of the adapted primary colors to realize a target white color. The target white color is a value determined when the image display device 1 is designed, and the luminance ratio of the primary colors of the display unit 10 has been adjusted to realize the target white color. However, since the viewer sees an image in external light, an adapted white color perceived by the viewer may be different from the target white color. Therefore, the luminance ratio of the adapted primary colors may be adjusted, so that the adapted white color perceived by the viewer is identical to the target white color.

A detailed description of the required luminance ratio calculation unit 33 will be given with reference to FIG. 6. Referring to FIG. 6, chromaticity coordinates of the target white color are (x, y)=(0.30, 0.31). When illuminance of external light is 0 lux, a viewer is unaffected by the external light. Therefore, the viewer perceives the primary colors of the display unit 10 as they are. In this case, a luminance ratio of the primary colors of the display unit 10 may be set to R:G:B=25%:66%:9% to realize the target white color.

However, when the illuminance of the external light is 500 lux, adapted primary colors perceived by the viewer change to (Rx, Ry), (Gx, Gy), (Bx, By)=(0.67, 0.33), (0.25, 0.70), (0.15, 0.07). Therefore, the luminance ratio of the adapted primary colors should be adjusted to R:G:B=24%:65%:11% in order to realize the target white color (x, y)=(0.30, 0.31) using the adapted primary colors for the external light with an illuminance of 500 lux.

The color correction data calculation unit 34 calculates color correction data indicating a gray level that corresponds to a required luminance ratio. The color correction data is related to the adjustment of the hues of the primary colors of the display unit 10.

For example, the color correction data indicating a gray level that corresponds to a required luminance ratio may be calculated using an inverse gamma curve. The color correction data reflects a change in the required luminance ratio. As the required luminance ratio increases or decreases, a value of the color correction data increases or decreases. Since the color correction data is related to grayscale, it is in a range of 0 to 255. Accordingly, although the required luminance ratio increases, the color correction data corresponding to the required luminance ratio cannot become greater than 255. Likewise, although the required luminance ratio decreases, the color correction data corresponding to the required luminance ratio cannot have a negative value.

A detailed description of the color correction data calculation unit 34 will be given with reference to FIGS. 6 and 7. FIG. 7 shows data on color correction data and a gamma set calculated according to illuminance of external light. The data shown in FIG. 7 has been obtained by calculating the color correction data, which corresponds to the required luminance ratio of FIG. 6, using an inverse gamma curve which is gamma 2.2.

For example, when the illuminance of the external light is 0 lux, the required luminance ratio is R:G:B=25%:66%:9%, and the color correction data corresponding to the required luminance ratio is (R, G, B)=(255, 255, 255). In addition, when the illuminance of the external light is 500 lux, the required luminance ratio is R:G:B=24%:65%:11%, and the color correction data corresponding to the required luminance ratio is (R, G, B)=(250, 253, 255).

In the case of R, a luminance percentage of 25% when the illuminance of the external light is 0 lux is reduced to 24% when the illuminance of external light is 500 lux. Accordingly, the color correction data is reduced from 255 to 250.

In the case of G, a luminance percentage of 66% when the illuminance of the external light is 0 lux is reduced to 65% when the illuminance of the external light is 500 lux. Accordingly, the color correction data is reduced from 255 to 253.

In the case of B, a luminance percentage of 9% when the illuminance of external light is 0 lux is increased to 11% when the illuminance of the external light is 500 lux. However, since the color correction data cannot be greater than 255, it is maintained at 255, just as when the illuminance of the external light is 0 lux.

The luminance correction data calculation unit 35 calculates the luminance correction data for adjusting the luminances of the primary colors of the display unit 10 based on the color correction data, so that an adapted white color estimated to be perceived by a viewer and a target white color have the same luminance.

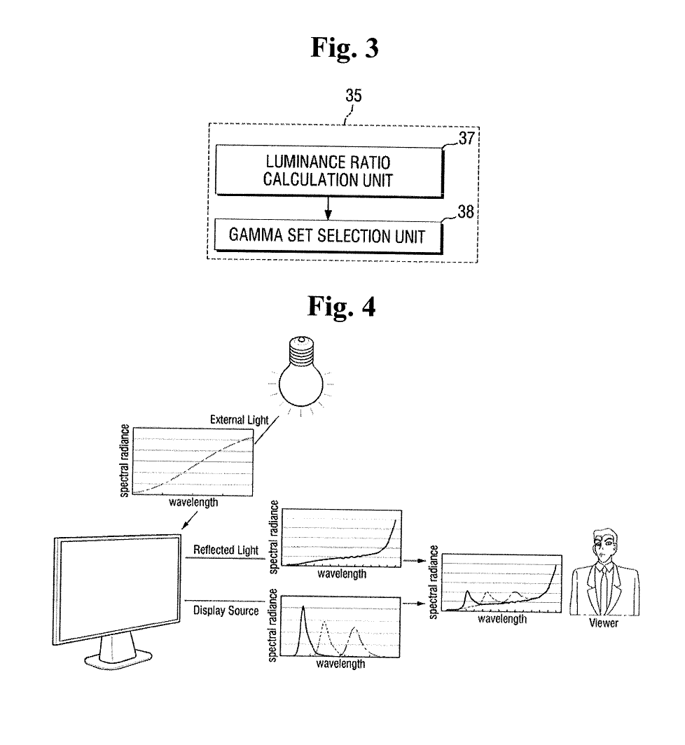

A detailed description of the luminance correction data calculation unit 35 will be given with reference to FIG. 3. FIG. 3 is a block diagram of the luminance correction data calculation unit 35 shown in FIG. 1.

Referring to FIG. 3, the luminance correction data calculation unit 35 includes a luminance ratio calculation unit 37 and a gamma set selection unit 38. The luminance ratio calculation unit 37 estimates an adapted white color and calculates a luminance ratio of the adapted white color. The gamma set selection unit 38 selects a gamma set which can compensate for the difference between the luminance ratio of the adapted white color and a luminance ratio of a target white color, such that the luminance ratio of the adapted white color becomes equal to the luminance ratio of the target white color equal.

The luminance ratio calculation unit 37 estimates an adapted white color perceived by a viewer in external light when the hues of the primary colors of the display unit 10 are adjusted based on the color correction data.

Referring to FIG. 7, when the hues of the primary colors of the display unit 10 are adjusted based on the color correction data, the difference between chromaticity coordinates of an adapted white color perceived by a viewer in external light and chromaticity coordinates of a target white color is less than ±0.007. Therefore, it can be understood that chromaticity-related distortion can be corrected using a color correction method of the image display device 1 according to the current exemplary embodiment.

Next, the luminance ratio of the adapted white color is estimated. Referring to FIG. 7, the luminance ratio of the adapted white color varies according to the illuminance of external light. The reason why the estimated adapted white color varies according to the illuminance of the external light is that some color correction data fails to reflect a change in the required luminance ratio since the color correction data is limited to a range of 0 to 255. Representative examples of such color correction data that does not reflect a change in the luminance ratio are the color correction data of B when the illuminance of the external light is 500 lux and the color correction data of R when the illuminance of external light is 1,000 lux. Due to such incorrect color correction data, the luminance ratio of the adapted white color in external light is lower than that of the target white color when the illuminance of the external light is 0 lux.

The gamma set selection unit 38 selects a gamma set which compensates for the difference between the luminance ratio of the target white color and that of the adapted white color, such that the luminance ratio of the adapted white color in external light becomes equal to the luminance ratio of the target white color. For example, referring to FIG. 7, when the illuminance of external light is 0 lux, the luminance ratio of the adapted white color is 1,000, and a value of the gamma set is 100%. When the illuminance of the external light is 500 lux, the luminance ratio of the adapted white color is reduced to 0.978 by 0.022. That is, the luminance ratio of the adapted white color when the illuminance of the external light is 500 lux is reduced from the luminance ratio of the adapted white color when the illuminance of the external light is 0 lux by 2.2%. Therefore, to compensate for this reduction in the luminance ratio, the gamma set when the illuminance of the external light is 500 lux may be determined to be 102% which is 2% higher than the gamma set determined when the illuminance of the external light is 0 lux.

A gamma set is a value related to a voltage level that can adjust the luminances of the primary colors of the display unit 10. That is, the voltage level may be adjusted to increase the luminance of the adapted white color by an amount corresponding to the value of the gamma set. The adjustment of the voltage level leads to a change in the luminances of the primary colors of the display unit 10. For example, in the process of correcting an image signal using a correction signal, a lookup table showing the relationship between the gamma set and the voltage level may be used. Consequently, data on the luminances of the primary colors of the display unit 10 in the image signal can be corrected.

A correction signal is generated by reflecting color correction data related to the adjustment of the hues of the primary colors of the display unit 10 and luminance correction data related to the adjustment of the luminances of the primary colors of the display unit 10. The correction signal is used to correct an image signal so that the hues and luminances of the primary colors of the display unit 10 can be adjusted. Consequently, the hue and luminance of an adapted white color become identical to those of a target white color, thereby maintaining color constancy and improving color visibility.

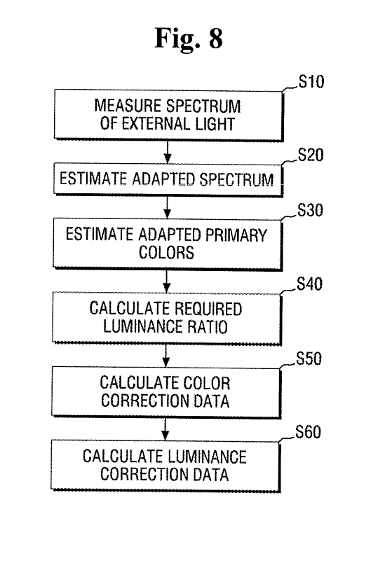

FIG. 8 is a flowchart illustrating a color correction method used by the image display device 1 of FIG. 1 according to an exemplary embodiment.

Referring to FIG. 8, in the color correction method, the spectrum of external light incident on the display unit 10 is measured in real time (operation S10). The display unit 10 displays an image according to an image signal.

An adapted primary color spectrum perceived by a viewer is estimated using the spectral reflectivity of the display unit 10, the maximum level primary color spectrum of the display unit 10, and the spectrum of the external light (operation S20). Specifically, the adapted primary color spectrum may be estimated by calculating the spectrum of reflected light, which is produced as the spectrum of the external light is reflected by the display unit 10, using the spectral reflectivity of the display unit 10 and the spectrum of the external light and by adding the spectrum of the reflected light and the maximum level primary color spectrum of the display unit 10.

Data on the spectral reflectivity of the display unit 10 and the maximum level primary color spectrum of the display unit 10 is measured before the measuring of the spectrum of the external light (operation S10). For example, the spectral reflectivity and maximum level primary color spectrum of the display unit 10 may be measured before the image display device 1 is shipped and may be stored in the memory unit 40.

Data on a target white color of the display unit 10 may also be determined before the measuring of the spectrum of the external light (operation S10). For example, the target white color may be determined before the image display device 1 is shipped and may be stored in the memory unit 40.

A correction signal for correcting the image signal may be provided based on the adapted primary color spectrum. Providing this correction signal may include estimating adapted primary colors using the adapted primary color spectrum (operation S30), calculating a required luminance ratio of the adapted primary colors for realizing a target white color (operation S40), calculating color correction data indicating a gray level that corresponds to the required luminance ratio (operation S50), and calculating luminance correction data for correcting luminances of the primary colors of the display unit 10 based on the color correction data such that an adapted white color perceived by a viewer and the target white color have the same luminance (operation S60).

In estimating the adapted primary colors (operation S30), chromaticity coordinates of the adapted primary colors are calculated by calculating tristimulus values of the adapted primary color spectrum. In addition, calculating the luminance correction data (operation S60) may include estimating the adapted white color, calculating a luminance ratio of the adapted white color, and selecting a gamma set which can compensate for the difference between the luminance ratio of the adapted white color and a luminance ratio of the target white color, such that the luminance ratio of the adapted white color becomes equal to that of the target white color. Ultimately, the correction signal is a signal that can correct the image signal to adjust the hues and luminances of the primary colors of the display unit 10.

By way of summation and review, due to the effect of external light, the luminance and color of the image displayed on the image display device may be different from those of the image perceived by the viewer. For example, the luminance and color of the image perceived by the viewer may appear distorted. Therefore, it may be difficult to identify a certain object in the image. In other words, image visibility is reduced.

Embodiments may be directed to an image display device, structured to enable the viewer to see an image thereon in external light without a reduction in luminance and a change in color. Embodiments may also be directed to a color correction method used by the image display device to correct the reduction in luminance and the change in color due to external light.

Exemplary embodiments have been disclosed herein, and although specific terms are employed, they are used and are to be interpreted in a generic and descriptive sense only and not for purpose of limitation.

What is claimed is:

1. An image display device, comprising:
a display unit displaying an image according to an image signal;
a sensor unit measuring a spectrum of external light incident on the display unit; and
a correction signal providing unit estimating an adapted primary color spectrum perceived by a viewer using spectral reflectivity of the display unit, a maximum level primary color spectrum of the display unit, and the spectrum of external light, and providing a correction signal for correcting the image signal based on the adapted primary color spectrum.

2. The image display device as claimed in claim 1, wherein the adapted primary color spectrum is estimated by calculating a spectrum of reflected light, which is produced as the spectrum of external light is reflected by the display unit, using the spectral reflectivity of the display unit and the spectrum of external light and by adding the spectrum of reflected light and the maximum level primary color spectrum.

3. The image display device as claimed in claim 1, further including a memory unit storing, before measuring the spectrum of external light, data on the spectral reflectivity, the maximum level primary color spectrum, and a target white color.

4. The image display device as claimed in claim 1, wherein the correction signal providing unit includes:
an adapted primary color estimation unit estimating adapted primary colors using the adapted primary color spectrum;
a required luminance ratio calculation unit calculating a required luminance ratio of the adapted primary colors for realizing a target white color;
a color correction data calculation unit calculating color correction data indicating a gray level which corresponds to the required luminance ratio; and
a luminance correction data calculation unit calculating luminance correction data for adjusting luminances of primary colors of the display unit based on the color correction data, such that an adapted white color estimated to be perceived by the viewer and the target white color have a same luminance,
wherein the correction signal is provided by reflecting the color correction data and the luminance correction data.

5. The image display device as claimed in claim 4, wherein the luminance correction data calculation unit includes:
a luminance ratio calculation unit estimating the adapted white color and calculating an adapted luminance ratio of the adapted white color; and
a gamma set selection unit selecting a gamma set which can compensate for a difference between the adapted luminance ratio of the adapted white color and a target luminance ratio of the target white color, such that the adapted luminance ratio of the adapted white color becomes equal to the target luminance ratio of the target white color,
wherein the luminance correction data is calculated by reflecting the gamma set.

6. The image display device as claimed in claim 4, wherein when the adapted primary colors are estimated, chromaticity coordinates of the adapted primary colors are calculated by calculating tristimulus values of the adapted primary color spectrum.

7. A color correction method used by an image display device, the method comprising:
measuring, in real time, a spectrum of external light incident on a display unit;
estimating an adapted primary color spectrum perceived by a viewer using spectral reflectivity of the display unit, a maximum level primary color spectrum of the display unit, and the spectrum of external light; and
providing a correction signal for correcting an image signal based on the adapted primary color spectrum,
wherein the display unit displays an image according to the image signal.

8. The method as claimed in claim 7, wherein estimating the adapted primary color spectrum includes:
calculating a spectrum of reflected light, which is produced as the spectrum of external light is reflected by the display unit, using the spectral reflectivity of the display unit and the spectrum of external light; and
adding the spectrum of reflected light and the maximum level primary color spectrum.

9. The method as claimed in claim 7, wherein data on the spectral reflectivity, the maximum level primary color spectrum, and a target white color are provided before measuring the spectrum of external light.

10. The method as claimed in claim 7, wherein providing the correction signal includes:
estimating adapted primary colors using the adapted primary color spectrum;
calculating a required luminance ratio of the adapted primary colors for realizing a target white color;
calculating color correction data indicating a gray level which corresponds to the required luminance ratio; and
calculating luminance correction data for adjusting luminances of primary colors of the display unit based on the color correction data, such that an adapted white color estimated to be perceived by the viewer and the target white color have a same luminance,
wherein the correction signal is provided by reflecting the color correction data and the luminance correction data.

11. The method as claimed in claim 10, wherein calculating the luminance correction data includes:
estimating the adapted white color and calculating an adapted luminance ratio of the adapted white color; and
selecting a gamma set which can compensate for a difference between the adapted luminance ratio of the adapted white color and a target luminance ratio of the target white color, such that the adapted luminance ratio of the adapted white color becomes equal to the target luminance ratio of the target white color,
wherein the luminance correction data is calculated by reflecting the gamma set.

12. The method as claimed in claim 10, wherein estimating the adapted primary colors includes calculating chromaticity coordinates of the adapted primary colors by calculating tristimulus values of the adapted primary color spectrum.
